(19) United States
(12) Patent Application Publication
(10) Pub. No.: US 2023/0302309 A1
(43) Pub. Date: Sep. 28, 2023

(54) SAFETY HARNESS WITH PSEUDO-CROSSOVER VENTRAL STRAPS

(71) Applicant: 3M INNOVATIVE PROPERTIES COMPANY, St. Paul, MN (US)

(72) Inventors: Michael T. Weiss, Hastings, MN (US); Nathan W. Safe, Red Wing, MN (US); Stephen D. Shaver, Cottage Grove, MN (US)

(21) Appl. No.: 18/018,806

(22) PCT Filed: Aug. 13, 2021
(86) PCT No.: PCT/IB2021/057495

§ 371 Date: Jan. 30, 2023

Related U.S. Application Data
(60) Provisional application No. 63/070,628, filed on Aug. 26, 2020.

(51) Int. Cl. A62B 35/00; A44B 11/25

(52) U.S. Cl. CPC A62B 35/0018; A44B 11/2519; A62B 35/0031

(57) ABSTRACT

A fall-protection safety harness with first and second ventral straps and with a ventral buckle that is at least generally aligned with a sagittal plane of the user, wherein the ventral buckle comprises first and second buckle portions mounted on the first and second ventral straps, respectively.

### BACKGROUND

Safety harnesses are often used to reduce the likelihood of a user experiencing a fall, and/or to safely arrest the user in the event of a fall. Such harnesses are often used in combination with one or more of a lanyard, a vertical safety system or ladder climb assist system, a self-retracting lifeline, and other fall-protection equipment.

### SUMMARY

In broad summary, herein is disclosed a fall-protection safety harness with first and second ventral straps and with a ventral buckle that is at least generally aligned with the sagittal plane of the user. These and other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a rear view of an exemplary fall-protection safety harness equipped with exemplary first and second buckle portions.

FIG. 2 is a front view of an exemplary fall-protection safety harness equipped with exemplary first and second buckle portions, with the harness partially donned by a user and with the first and second buckle portions not yet attached to each other.

FIG. 3 is a front view of the exemplary fall-protection safety harness of FIG. 2, as fully donned by a user with the first and second buckle portions having been attached to each other to form a ventral buckle.

FIG. 4 is a front view of an exemplary ventral buckle.

FIG. 5 is a front view of exemplary first and second buckle portions that can be attached to each other to form the ventral buckle of FIG. 4.

FIG. 6 is a front, partially exploded view of the exemplary first buckle portion of FIG. 5.

FIG. 7 is a front view of another exemplary ventral buckle.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated. Although terms such as “first” and “second” may be used in this disclosure, it should be understood that those terms are used in their relative sense only unless otherwise noted. As used herein as a modifier to a property or attribute, the term “generally”, unless otherwise specifically defined, means that the property or attribute would be readily recognizable by a person of ordinary skill but without requiring a high degree of approximation.

The following terminology is defined with respect to a fall-protection safety harness as worn by such a user standing upright. The descriptions of positions, orientations, and so on, of harness components as disclosed herein, including in the claims, are thus with respect to the harness as worn by a user standing upright, unless stated otherwise. However, this terminology is used for clarity of description and does not limit the actual orientation of the harness and components thereof during use in a workplace.

Terms such as vertical, upward and downward, upper, lower, above and below, and like terminology, correspond to conventional directions when the harness is worn by a user who is standing upright. The vertical axis (v) is denoted in various Figures herein. The transverse direction refers to the conventional right-left direction of the user and harness, as indicated by transverse axis (t) in various Figures herein. The term ventral refers to the front side of the user's upper body and to harness portions and components located there; the term dorsal refers to the rear side of the user's upper body and to harness portions and components located there. The dorsal-ventral direction is the direction that extends forward-rearward through the user's body (specifically, through the torso), as indicated by dorsal-ventral axis (d-v) in various Figures herein.

Terms such as inward, unless otherwise specified, denote a direction that is inward toward the user's body along the dorsal-ventral axis; terms such as outward, unless otherwise specified, denote a direction that is outward away from the user's body along the dorsal-ventral axis. Terms such as transversely-inward and transversely-outward are exceptions to this usage; they denote directions respectively toward and away from the sagittal plane of the user's body and of the harness, along the transverse (t) axis.

As used herein, the sagittal plane (sometimes referred to as the mid-sagittal plane) has its conventional meaning as a vertical plane that extends down the transverse centerline of the user's body to symmetrically divide the user's body into left and right portions; the term sagittal also applies to the herein-disclosed harness as worn by such a user in an upright position. A sagittal plane is depicted as item 501 in FIG. 9 of U.S. Patent Application Publication 2015/0165246, which is incorporated by reference herein for this purpose.

### DETAILED DESCRIPTION

Fall-protection safety harnesses, sometimes referred to as full-body safety harnesses, are widely used in circumstances in which workers are at elevated height or are otherwise at risk of falling. A fall-protection safety harness is configured to serve in combination with a fall-protection device or apparatus such as, e.g., a self-retracting lifeline, a horizontal lifeline, a lanyard or the like, to provide fall protection. Thus in ordinary use, at least one such fall-protection device is typically connected to the safety harness, e.g., to a D-ring (or other suitable connection point) borne by the harness. Fall-protection safety harnesses will be distinguished from, for example, general-use items such as backpacks and the like.

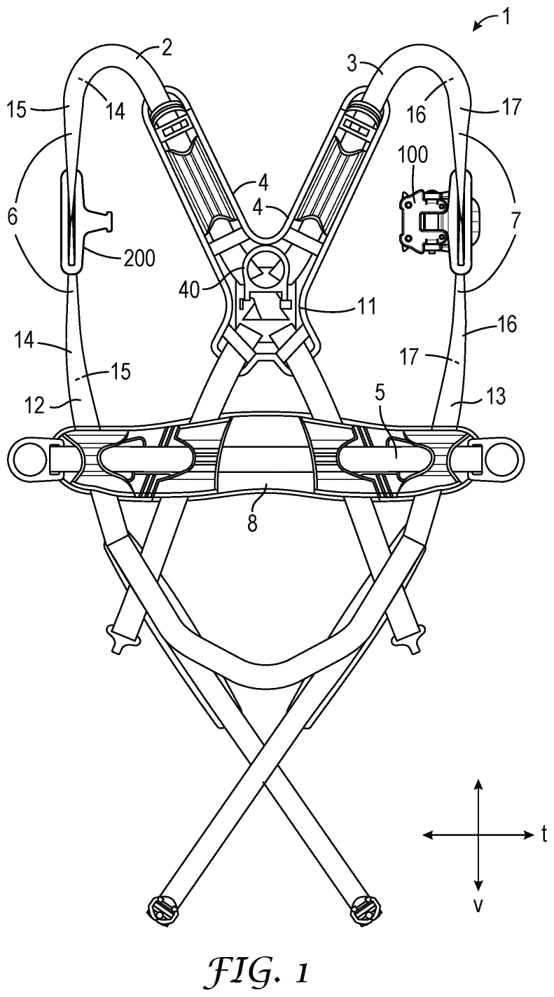

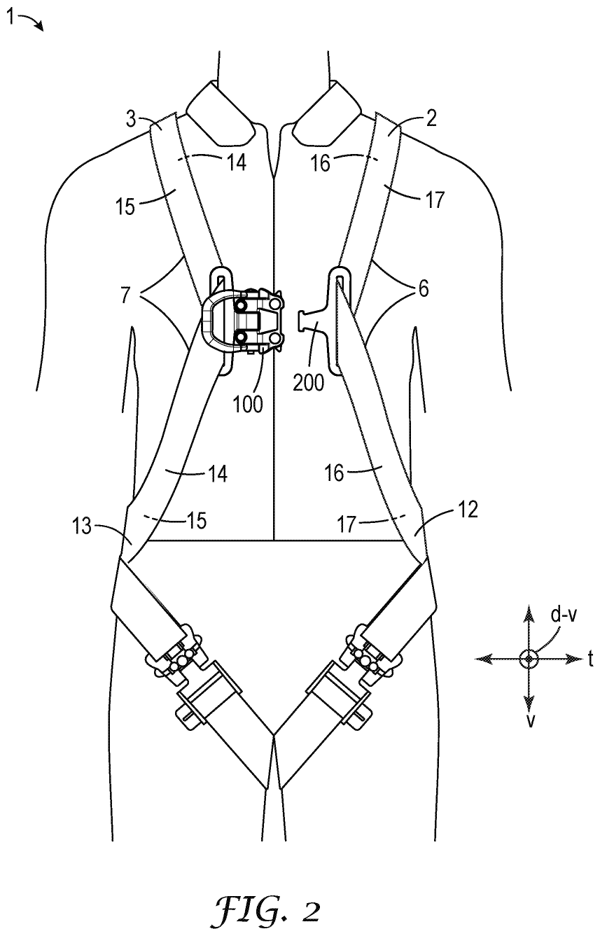

As illustrated in generic representation in FIGS. 1-3, a fall-protection safety harness 1 will comprise an assembly of straps and associated items that can collectively support the weight of a user (wearer) of the harness in the event of a fall. The depictions of FIGS. 1 and 2 are intended as exemplary representations; in actuality a safety harness may vary in some aspects from the particular arrangements shown in these Figures. Also, the exemplary harnesses of FIGS. 1 and 2 differ in various ways and are not to be interpreted as different views of the same harness.

The straps of such a harness are often comprised of flat webbing, made of, e.g., woven synthetic fabric such as, e.g., polyamide, polyaramid (such as, e.g., Kevlar), ultra-high molecular weight polyethylene (such as, e.g., Dyneema) and the like. Such straps are typically flexible so that they can conform to the surface of a wearer's body, can be passed through one or more of buckles, guides, loops and the like, but typically are not significantly extensible. Such straps are interconnected with each other and are often fitted with various pads (e.g., shoulder pads 4 and waist/hip pad 8) to enhance the comfort of the harness, as well as various buckles, latches, connectors, loops, guides, additional pads such as, e.g., chest pads and/or leg pads, and so on. Such components and exemplary arrangements of such components are described in, for example, U.S. Pat. Nos. 8,959,664, 9,174,073, and 10137322, all of which are incorporated by reference in their entirety herein.

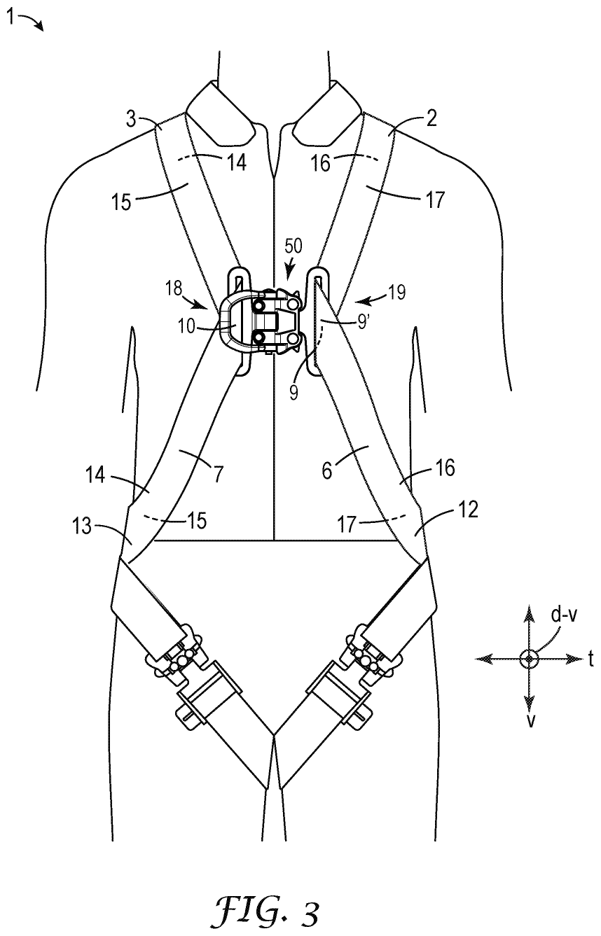

A safety harness 1 typically includes first and second (right and left) straps 3 and 2 that extend over the top of the user's shoulders as shown in FIGS. 2 and 3. FIG. 2 depicts a harness that has been partially donned with first and second buckle portions 100 and 200 not yet having been attached to each other; FIG. 3 depicts such a harness having been fully donned with buckle portions 100 and 200 having been attached to each other to form a ventral buckle 50 as discussed in detail later herein.

On the ventral (front) side of the wearer, shoulder straps 3 and 2 continue generally downward along the wearer's torso as seen in FIGS. 2 and 3 At such locations these straps will be referred to herein as ventral straps 7 and 6 (noting that each ventral strap is often an uninterrupted continuation of a shoulder strap, as evident from FIGS. 1-3). First and second ventral straps 7 and 6 will extend generally downward along the user's torso so that lowermost sections 12 and 13 of straps 7 and 6 will reside at or near the users hips. Often, lowermost sections 12 and 13 of ventral straps 6 and 7 will meet and, e.g., interconnect with a strap 5 (which may be termed a waist strap, hip strap, etc.) that encircles at least a portion of the waist/hip area of the user as shown in FIG. 1. (In various harness designs, a waist strap may or may not be present.) In many embodiments, ventral straps 6 and/or 7 may each be a single piece of webbing that extends continuously from the shoulder to the hip. In other embodiments, a ventral strap 6 and/or 7 may take the form of two individual pieces of webbing that are attached to each other at some location along strap 6 or 7 (by definition, such a location will not be at the ventral buckle). All such design variations are encompassed by the term “strap” as used herein.

In many safety harness designs, the first and second shoulder straps 3 and 2, on the rear (dorsal) side of the wearer's torso, will meet, overlap and cross each other at a dorsal crossing point located, e.g., between the shoulder blades. In some embodiments, a dorsal plate 11 and/or a dorsal pad 4 (which may continue upward to serve as a shoulder pad) may be present, as in the exemplary design of FIG. 1. Often a dorsal D-ring 40 is provided at such a location as shown in FIG. 1. Some safety harnesses, e.g., multipurpose safety harnesses, harnesses specifically configured for use with a vertical or climb assist system, and so on, may comprise a ventral D-ring 104 as illustrated in various Figures herein. (D-rings may also be provided at other locations, e.g., at the hips, as evident in the exemplary design of FIG. 1.)

In some embodiments, harness 1 will also include leg or thigh straps (shown, unnumbered, in FIGS. 1-3); in various embodiments some such straps may or may not be a continuation of a ventral strap. In some embodiments a fall-protection safety harness may or may not include one or more plates (e.g., a dorsal plate as mentioned above) that may be relatively rigid (e.g., made of molded plastic and/or metal) in comparison to other, relatively flexible harness components such as pads and cushions. Although not shown in the Figures herein, in some embodiments a ventral strap 6 and/or 7 (and/or any other strap, e.g., waist strap, leg strap and so on), may be equipped with a strap adjuster that can be used to adjust the length of the strap as desired. Exemplary strap adjusters are described, e.g., in U.S. Pat. No. 8,794,378. The disclosures herein will make it clear that a ventral buckle as disclosed herein is distinguished from a strap adjuster. A harness as disclosed herein will not necessarily require, and in many embodiments will not include, a coupler strap (i.e., a generally horizontal, transversely-extending strap that extends between left and right chest straps of a conventional H-style harness to each other, as exemplified by item 202 of FIG. 1 of U.S. Pat. No. 9,993,048).

Fall-protection safety harnesses have conventionally been of two general types. In one general type of harness, one ventral strap extends from the right shoulder to the right hip of the user, and the other strap extends from the left shoulder to the left hip. Often, such ventral straps descend along the user's torso along a generally vertical, straight path. Such harnesses (which are sometimes referred to as H-style harnesses) conventionally include a coupler strap of the general type mentioned above, that extends generally transversely from one ventral strap to the other ventral strap (i.e., that forms the horizontal crossbar of the “H”). Such harnesses have the advantage that they can be donned relatively easily, e.g., in the general manner of a jacket or vest. That is, the ventral straps of such a harness can be forwardly wrapped around the upper torso, after which the chest-strap coupler is used to establish a connection between the two ventral straps.

A second general type of harness is a so-called crossover-style harness. In such a harness, one ventral strap extends from the right shoulder to the left hip, and the other ventral strap extends from the left shoulder to the right hip. (Here and elsewhere, the term shoulder refers to the general region extending from the transverse edge of the neck to the transversely-outer limit of the deltoid muscle. Similarly, the term hip encompasses the general region from the rectus abdominis muscle to the muscles and tissues laterally overlying the iliac crest). The ventral straps thus cross each other, e.g., in the vicinity of the user's breastbone. Such harnesses can have advantages in redistributing asymmetric forces that may result, e.g., from a heavy tool hanging on a user's hip. Such harnesses can also advantageously position a ventral D-ring near the transverse center of the user's torso (the sagittal plane), which can be particularly advantageous for female users and/or when the harness is used in combination with a vertical safety system, climbing-assist system, or the like. This can be achieved while advantageously having the D-ring directly connected to ventral straps rather than being connected to an above-described coupler strap. However, a crossover-style harness has the disadvantage that the harness cannot be donned like a jacket or vest. Rather, the harness must be pulled downward over the user's head in the general manner of a pullover sweater. This can be cumbersome, particularly for a novice user of the harness, and can lead to a momentarily confusing tangle of straps.

Pseudo-Crossover Design

The present design is a pseudo-crossover design which preserves the advantages of both types of harnesses. By definition, a pseudo-crossover design denotes an arrangement in which a first ventral strap 7 of the harness extends from the right shoulder of the user to the right hip of the user, and a second ventral strap 6 of the harness extends from the left shoulder of the user to the left hip of the user, as in an H-style harness. However, each ventral strap does not extend generally straight vertically downward along the user's torso in the usual manner of an H-style harness. Instead, each ventral strap, as it extends downward from the user's shoulder, deviates transversely inwardly (toward the sagittal plane of the user and harness) so that the ventral straps approach each other closely (e.g., within 10 cm) at a ventral buckle 50 in the general manner shown in FIG. 3. Then, as each ventral strap continues downward from the ventral buckle, it deviates transversely outward so that it extends to the hip that is on the same side as the shoulder from which the ventral strap originated, as evident in FIG. 3.

In some embodiments, this can be achieved by mounting a first buckle portion 100 on first ventral strap 7, and by mounting a second buckle portion 200 on second ventral strap 6, as shown in FIG. 2. When donning the harness, the two buckle portions 100 and 200 can be moved transversely inward toward each other (i.e., toward the sagittal plane of the user) and detachably attached to each other to form ventral buckle 50 as shown in FIG. 3. It will be appreciated that this can be performed in generally similar manner to the donning of an H-style harness rather than the harness having to be pulled downward over the user's head.

In a pseudo-crossover design, the ventral buckle 50 will be at least generally aligned with the sagittal plane of the user and of the harness, as is evident from FIG. 3. By this is meant that the ventral buckle will be at least generally centered with respect to the right-left (transverse) axis of the user and harness, so that the sagittal plane passes through at least some portion of the ventral buckle. Often, the sagittal plane may pass near, or very close to (e. g. within 4, 2 or 1 cm of), the transverse center of the buckle.

However, in many embodiments, no portion of either first ventral strap 7 or second ventral strap 6 will be aligned with the sagittal plane of the user and harness. In other words, in such embodiments, the ventral straps may be transversely spaced apart from each other, transversely outward from the sagittal plane, so that the sagittal plane will not pass through any portion of either ventral strap, as exemplified by the arrangement depicted in FIG. 3. Furthermore, in such embodiments, no portion of either ventral strap will be in overlapping relation with any portion of the other ventral strap, again as evident from FIG. 3. By any two (or more) items being overlapping relation is meant that a line that passes through at least some part of one of the items, along a dorsal-ventral direction, will also pass through at least some part of the other item. It will be understood that the above conditions apply when the harness straps are all in a stable, properly and snugly fitted condition, notwithstanding that these conditions may be momentarily violated, e.g., when the user of the harness is twisting, bending, or in the process of donning the harness.

180 Degree Twist of Ventral Strap

In many embodiments, at least one of the first and second ventral straps 7 and/or 6, and the buckle portion (100 and/or 200) that is mounted on that ventral strap, may be configured so that the ventral strap exhibits a 180 degree twist. By a 180 degree twist is meant that as the ventral strap progresses downward along the user's torso, it goes through a 180 rotation about an axis of rotation that is generally aligned with the long axis of the ventral strap so that a major surface that faces inward (toward the user's body) in a section of the strap that is above the ventral buckle, faces outward (away from the user's body) in a section of the strap that is below the ventral buckle (and vice versa).

Thus with reference to exemplary ventral strap 7 as shown in FIG. 3, major surface 14 of strap 7 faces inward on the user's upper chest and faces outward on the user's lower abdomen; the converse is true for opposing major surface 15 of strap 7. Similarly for strap 6 of FIG. 3, major surfaces 16 and 17 respectively trade inward-outward orientations above and below the ventral buckle 50. Thus, in the depicted embodiment of FIG. 3, ventral straps 7 and 6 are each configured to comprise a 180 degree twist 18 and 19. In some embodiments, only a single ventral strap may be configured in such manner. In such a case, the other strap may, for example, be configured more or less vertically in the general manner of a ventral strap of a conventional H-style harness. However, in many embodiments it may be advantageous to configure both of the ventral straps with a 180 degree twist.

In many embodiments, the buckle portion that is mounted on the ventral strap may be configured to dictate that the 180 degree twist occurs at the buckle portion (as for exemplary 180 degree twists 18 and 19 depicted in FIG. 3). By “at” means within a few (e.g., 4, 2, or 1) cm of the buckle portion. In some embodiments, such an arrangement can be promoted by providing the buckle portion with an at least generally vertically-elongate slot through which the ventral strap passes. (Such a slot may be referred to occasionally herein as a vertically-elongate slot; it will be understood that this signifies at least generally vertically-elongate unless otherwise specified.) Such slots are partially visible in FIGS. 1-3; exemplary slots of this type are more easily visible as slots 106 and 202 of buckle portions 100 and 200 as shown in FIG. 4. By a slot is meant a through-opening that is elongated so as to have a readily recognizable long axis and that exhibits an elongate length that is at least as great as the lateral (crossweb) width of the strap that is to pass through the slot. In many embodiments, such a slot will be at least generally vertically-elongate, meaning that the long axis of the slot is oriented within plus or minus 20 degrees of the vertical axis of the user and harness. In some embodiments such a slot will be at least substantially vertically-elongate, meaning that the long axis of the slot is oriented within plus or minus 10 degrees of the vertical axis. (The exemplary arrangement of FIGS. 3 and 4 depicts slots that are very close to strictly vertically oriented.) The second major dimension of the slot (e.g., the “width” of the slot, which extends along the transverse direction in FIGS. 3 and 4) need only be enough to accommodate the thickness dimension of the strap that passes through the slot. The final (third) dimension of the slot (which extends in the distal-ventral direction, e.g., in and out of plane in FIGS. 3 and 4) can be any suitable value, e.g., dictated by the thickness of the body that defines the slot.

As illustrated in exemplary manner in FIG. 3, the providing of an at least generally vertically-elongate slot through which a ventral strap is forced to pass, can cause the ventral strap to perform a 180 degree twist at the buckle portion in which the slot is provided. In other words, the ventral strap may exhibit the 180 degree twist in the local area in which the ventral strap approaches, passes through, and exits the generally vertically-elongate slot.

In at least some embodiments, a ventral strap may exhibit features that are indicative of a 180 degree twist. Thus in some embodiments such a ventral strap may comprise first and second strap sections that are in overlapping relation with each other, as exemplified by sections 9 and 9′ of ventral strap 6 as indicated in FIG. 3. These sections are in overlapping relation, with section 9′ being outward and section 9 being inward. Furthermore, in some such embodiments, at least a portion of each of these strap sections may also be in overlapping relation with an area of the buckle portion that partially defines the generally vertically-elongate slot of the buckle portion. While such an area is not visible in FIG. 3 due to it being overlapped and obscured by section 9 of the strap itself, such an area is indicated as area 211 (that partially defines slot 202) in FIG. 4. A similar area is indicated as area 311 in FIG. 7.

In the exemplary arrangement of FIG. 3, at the point of overlap, the lower portion of each ventral strap is routed outward (along the dorsal-ventral direction) of the upper portion of each ventral strap. (For example, for strap 6, section 9′ is positioned outward of section 9.) This is optional and can easily be reversed, e.g., with the upper portion of one or both straps routed outward of the lower portion of that strap.

In some embodiments, a generally vertically-elongate slot (e.g., slot 106 or 202 of buckle portion 100 or 200) may function in a standalone manner. However, in some embodiments one or more auxiliary slots may be provided in order to enhance the guiding of the ventral straps and in particular to enhance the degree to which the 180 degree twist is compelled to occur at the generally vertically-elongate slot. An exemplary arrangement of this general type is shown in FIG. 7. In this Figure, first buckle portion 100 (whose other components and functions will be discussed in detail later herein) comprises a generally vertically-elongate slot 402 that is similar in form and function to slot 106 of FIG. 4. Buckle portion 100 also comprises two (upper and lower) auxiliary slots 406 and 407. Although a strap is not depicted in FIG. 7 so that other items and features can be more easily seen, it is readily apparent how a strap can be guided downward and transversely-inwardly at a desired angle that is established by slot 406, can then pass into and through vertically-elongate slot 402, and can then be guided downward and transversely-outwardly at an angle that is established by slot 407. In such a case, the 180 degree twist will occur at slot 402.

In various embodiments, only a single auxiliary slot (e.g., an upper slot or a lower slot) may be present; or, two (or more) auxiliary slots may be used. The angle of such a slot may be chosen as desired and will be defined in terms of the orientation of the long axis of the auxiliary slot, relative to the long axis of the vertically-elongate slot. In various embodiments such an auxiliary slot may exhibit a long axis that is oriented at an angle of at least 10, 15, 20, 25, or 30 degrees relative to the vertically-elongate slot. In further embodiments such an auxiliary slot may exhibit a long axis that is oriented at an angle of at most 60, 50, 40 or 30 degrees relative to the vertically-elongate slot. By way of a specific example, in the exemplary arrangement of FIG. 7, auxiliary slot 306 is oriented at an angle of approximately 35 degrees relative to vertically-elongate slot 302.

Whatever the specific angle, any such auxiliary slot by definition will be oriented so that the terminal end of the auxiliary slot that is closest to the vertical midpoint of the vertically-elongate slot, will be further away from the vertically-elongate slot than the other, opposing terminal end of the auxiliary slot. (In other words, the distance from the lower end of auxiliary slot 306 to the closest point of vertically-elongate slot 302, is greater than the distance from the upper end of auxiliary slot 306 to the closest point of vertically-elongate slot 302, as is readily apparent from FIG. 7.) When upper and lower auxiliary slots are present, such a requirement will dictate that the upper and lower auxiliary slots are oppositely-angled relative to the vertically-elongate slot, which is again apparent from FIG. 7. Given the disclosures herein, an ordinary artisan will readily understand how such an arrangement of auxiliary slots can enhance the guiding of the strap so as to promote the herein-disclosed 180 degree twisting.

Although not discussed in detail herein, the other buckle portion may similarly comprise one or more auxiliary slots of similar design to those discussed above. Thus in FIG. 7, second buckle portion comprises upper and lower auxiliary slots 306 and 307, in addition to vertically-elongate slot 302. Although the upper and lower auxiliary slots depicted in FIG. 7 are symmetrical (e.g., they are oriented at equal, although opposite, angles with respect to the vertically-elongate slot that they accompany), this does not necessarily have to be the case. For example, a lower auxiliary slot may be oriented at a different angle than an upper auxiliary slot.

In various embodiments, at least 60, 70, 80, 90, 95, or 98 percent of the elongate length of an auxiliary slot may be positioned transversely outward of all portions of the vertically-elongate slot. By way of a specific example, in the exemplary arrangement of FIG. 7 it appears that at least 90 percent of the elongate lengths of auxiliary slots 306 and 307 are positioned transversely outward of all portions of vertically-elongate slot 302.

In conventional design of slots and guides for straps of harnesses, a slot or guide is often chosen to have an elongate length that is only slightly greater than the lateral (crossweb) width of the strap, in order that the strap can fit through the slot. It will be appreciated that a slot as disclosed herein, which serves the specific purpose of guiding a strap through a 180 degree twist, may advantageously be chosen to have an elongate length that is significantly greater than the lateral width of the strap that passes through it. Thus in various embodiments the ratio of the elongate length of an at least generally vertically oriented slot of a buckle portion to the lateral width of the strap that passes through the slot, may be at least 1.2, 1.4, 1.6, 1.8, or 2.0. In further embodiments, this ratio may be at most 4.0, 3.5, 3.0, 2.5, 2.2, or 1.9.

A ventral buckle as disclosed herein will comprise an at least generally vertically-oriented slot as described herein (as well as any optional auxiliary slot that may be used in conjunction with it). All such slots will be configured to have a strap pass through the slot and continue onward. This will be distinguished from a buckle slot that is configured to have a strap pass therethrough so as to attach the strap to the buckle. For example, for some purposes a strap may be attached to a buckle portion by passing an end section of the strap through a slot, turning this end section of the strap back on itself, and then sewing, stitching, or otherwise attaching the strap to itself to form a terminal loop that attaches the strap to the buckle portion. Such attachment will typically be at the factory where the buckle and harness is made; the strap will typically remain attached to the buckle portion at all times. Such a buckle portion will be distinguished from a ventral buckle portion as disclosed herein.

The condition of a 180 degree twist, and in particular a stipulation that the 180 degree twist may occur at a buckle portion, e.g., as dictated by a vertically-elongate slot, is applicable when the harness is fully donned with the buckle portions having been attached to each other to form the ventral buckle, e.g., as shown in FIG. 3. With the harness not being worn (as in FIG. 1), or being partially donned (as in FIG. 2), the arrangements and geometric relationships disclosed herein may not be as apparent. Thus, whether or not a ventral strap exhibits a 180 degree twist as described herein will be evaluated with the harness fully donned and properly fitted to a user in the manner required by the manufacturer. In particular, the arrangements disclosed herein, in which a 180 degree twist is purposefully incorporated into a ventral strap of a harness, will be distinguished from situations in which, for example, a ventral strap becomes twisted due to a user donning the harness incorrectly (e.g., accidentally twisting a strap). In the present arrangements, the 180 degree twist is built in to the ventral strap as the harness is made at the factory, e.g., by attaching (e.g., sewing) the various straps to each other, to buckles and so on, in a chosen, permanent configuration. In other words, the herein-disclosed 180 degree twist cannot be eliminated by untwisting the ventral strap or any strap to which it might be connected.

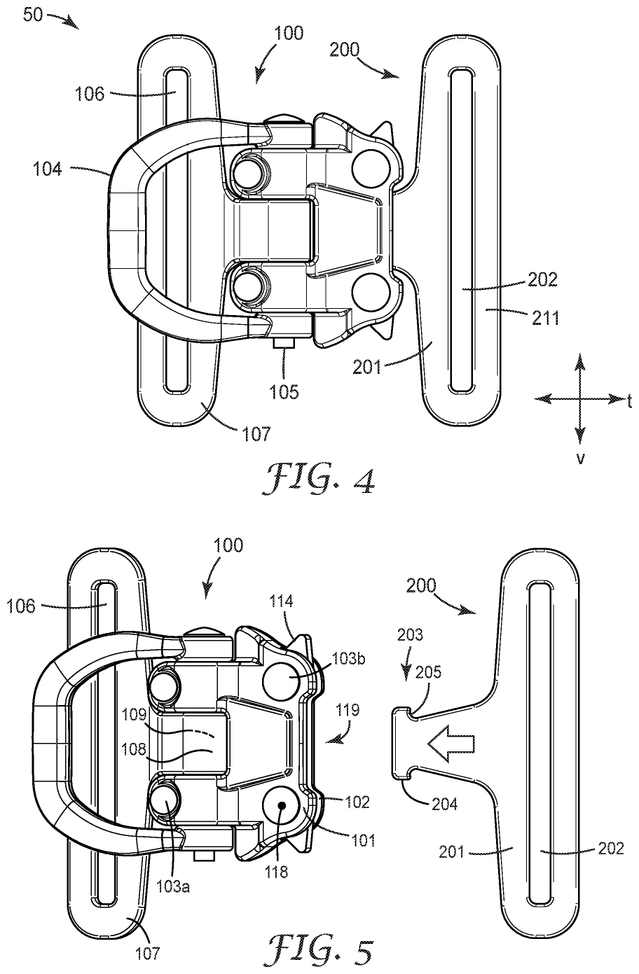

Exemplary buckle designs that may achieve the above-described effects are depicted in FIGS. 4-7. In some exemplary embodiments a ventral buckle 50 may be provided in the form of two buckle portions 100 and 200, which can be detachably attached to each other to form buckle 50. In the exemplary arrangement depicted in these Figure, first and second buckle portions 100 and 200 will respectively be “female” and “male” buckle portions, accordingly to terminology commonly used in the art to describe such buckles. (Either such buckle portion may be mounted on a left ventral strap, or on a right ventral strap.) A female buckle portion 100 will comprise an opening 119 configured to selectively receive a complementary catch 203 of male buckle portion 200, as evident in FIG. 5. By “complementary” and “selectively” is meant that buckle portions 100 and 200 are each configured to be mateable with a counterpart buckle portion that is specifically designed to be mateable therewith. Such designs will be contrasted with, for example, “universal” buckles or connectors. (Universal buckles may be used in some embodiments if desired.)

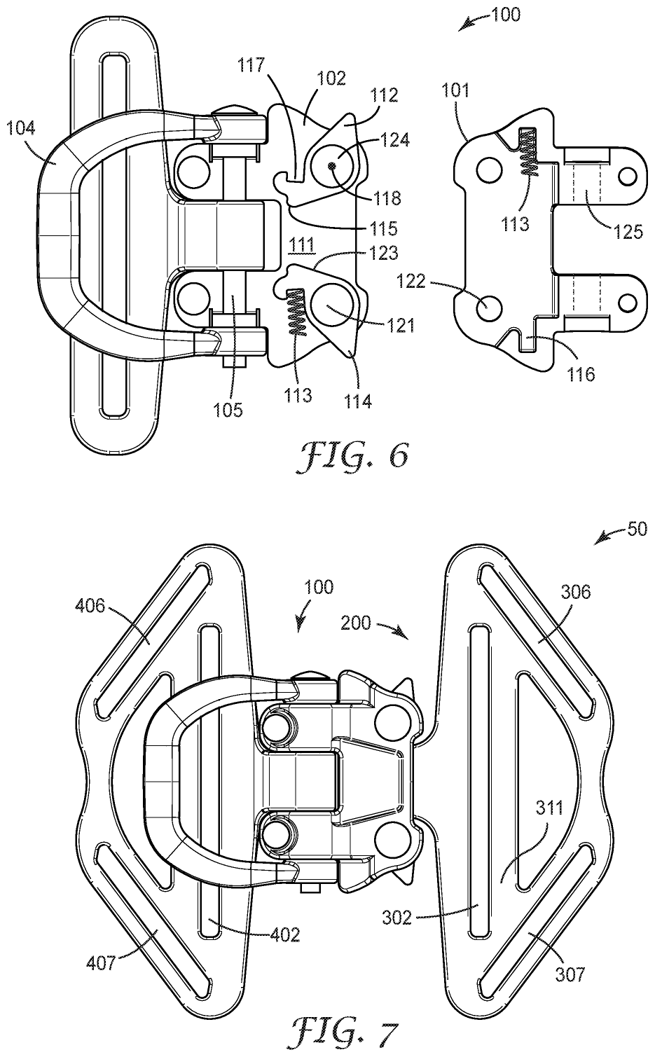

In some embodiments, a first (e.g., female) buckle portion 100 will include a base plate 101 and a cover plate 102. Base plate 101, and a portion of cover plate 102, are visible in FIG. 5. These items are more easily visible in FIG. 6, which presents a view in which base plate 101 has been exploded away from, and rotated 180 degrees relative to, cover plate 102. That is, in FIG. 6 base plate 101 has been opened from cover plate 102 in clamshell fashion so that additional components and features of cover plate 102 can be seen, and so that components and features on the underside of base plate 101 can be seen. (Also, in FIG. 6 various fasteners have been omitted so that other features may be more easily seen.) In various embodiments plates 101 and 102 (and other components associated therewith) may be made of, e.g., a metal such as steel or aluminum. Various mechanical fasteners (e.g., rivets) 103 may be used to permanently hold plates 101 and 102 together. Various through-holes can be provided in the plates to accommodate such fasteners, as is evident in the view of FIG. 6.

In some embodiments, a first buckle portion 100 will comprise at least one latch that is pivotably attached to the first buckle portion and that is configured to selectively engage a catch 203 of the second buckle portion 200 to securely lock catch 203 within an interior space (receiving cavity) 111 of first buckle portion 100. In some particular embodiments, the at least one latch may take the form of first and second pivotable latches 112 as visible in FIG. 6. Such latches may be pivotably coupled to first buckle portion 100, in such manner as to be (partially) rotatable about a rotation axis 118 as indicated in FIGS. 5 and 6. Thus in the illustrated embodiment, a latch 112 will be pivotably connected to buckle portion 100 by way of a mechanical fastener (e.g., rivet) 103b that passes through aligned apertures 122, 121 and 124 of base plate 101, cover plate 102, and latch 112, with the mechanical fastener 103b establishing the axis of rotation 118 of the pivotable latch. (Other fasteners 103a pass through various similarly-aligned apertures in the base plate and cover plate; these assist in holding the plates together but do not interact with the latches.)

In the illustrated embodiment, pivotable latches 112 are inwardly-biased. In this instance, by inwardly-biased is meant that portions of the latches that will physically contact the catch of the second buckle portion when the latches are in their second, latched position (i.e., “shoulders” 115 as indicated in FIG. 6) are biased inward, toward each other. Such biasing may be achieved e.g., by the use of biasing members 113 as shown in FIG. 6. In some embodiments, biasing members 113 may take the form of coil springs 113 that are mounted in compression in channels 116 and 117 respectively provided in base plate 101 and latch 112. Such an arrangement is depicted in FIG. 6. (In FIG. 6, one of springs remains with cover plate 102 and latch 112, the other spring has been exploded with base plate 101, in order that the positions of the springs can be fully illustrated.)

Such an arrangement of a first buckle portion 100 comprising pivotable, inwardly-biased latches 112 may be used in combination with a second buckle portion 200 (e.g., a “male” portion) bearing a generally T-shaped catch 203 that extends from a main body 201 and that comprises protruding teeth 204 as shown in FIG. 5. As catch 203 is inserted into opening 119 of first buckle portion 100 (as indicated by the block arrow in FIG. 5), catch 203 will enter the receiving cavity 111 of the first buckle portion. The edges of the leading end of catch 203 will impinge on sloped contact surfaces 123 of latches 112 (visible in FIG. 6) and will overcome the biasing force of springs 113 and urge latches 112 to pivot in a direction that moves the shoulders 115 of latches 112 away from one another. Upon continued penetration of the catch deeper into cavity 111, the teeth 204 of catch 203 will travel so far that latches 112 are able to pivotably rotate under the biasing force of springs 113 so that shoulders 115 of latches 112 fit into spaces 205 proximate the teeth 204 of the catch. This will securely hold the catch 203 of second buckle portion 200 within receiving cavity 111 of first portion 100 thus securing the first and second buckle portions together as shown in FIG. 4. Such a configuration of the latches will be referred to as a second, latched position.

Catch 203 cannot thereafter be removed from receiving cavity 111 (thus the first and second buckle portions cannot be detached from each other) unless latches 112 are manually pivotably moved (rotated) out of the second, latched position, into a first, unlatched position. To accomplish this, a user can use, e.g., the thumb and forefinger to urge manipulation portions (“ears” 114, that are exposed beyond the edges of plates 101 and 102 as shown in FIG. 5) of latches 112 generally rearward (in this instance, “rearward” means away from the main body of first buckle portion 100). This will cause latches 112 to rotate (overcoming the biasing force of springs 113) so that the shoulders 115 of the latches 112 move far enough apart to reach a first, unlatched position, that allows the catch 203 of the second buckle portion to be removed from the first buckle portion.

Based on the discussions above it will be appreciated that in some embodiments a latching system as disclosed herein may be automatically latching (e.g., self-latching), meaning that the engaging of the catch of the second buckle portion with the pivotable latches of the first buckle portion can occur automatically upon insertion of the catch into the receiving cavity of the first buckle portion. That is, no manipulation of the pivotable latches by the fingers of the user is required in order to attach the first and second buckle portions to each other to form the ventral buckle.

In contrast, in the depicted embodiment the disengaging of the catch from the pivotable latches to detach the buckle portions from each other requires deliberate manual actuation. That is, a preliminary step of manually pivotably moving the latches to an unlatched position (overcoming the biasing force) must be performed before the catch can be removed from the receiving cavity. Thus in at least some embodiments, the first and second buckle portions can be automatically attached to each other as a consequence of moving the buckle portions toward each other; while, in contrast, a preliminary step of pivotably moving the latches to unlatch them must be manually performed in order to allow the first and second buckle portions to be detached from each other.

Based on the above discussions, it will be evident that when the buckle portions 100 and 200 are separated from each other (e.g., when the harness is not being worn by a user) the biasing force of the biasing members will cause the latches to be held in their second, latched position (although no catch will be present to be secured in the receiving cavity). To don the harness, the upper portions of the harness are wrapped forwardly about the shoulders and the right and left ventral straps are positioned on right and left sides of the upper torso. The first and second buckle portions are then moved transversely inward toward the sagittal plane of the user and toward each other, so that the catch of the second buckle portion enters the receiving cavity of the first buckle portion. The leading edges of the catch will impinge on the latches and will overcome the biasing force and urge the latches to momentarily move to the first, unlatched position to allow the catch to be captured, and the buckle portions attached to each other, as described above. In this capturing process, the latches will automatically return to the second, latched position under the influence of the biasing force.

When the harness is to be removed, the user will manually manipulate the latches to the first, unlatched position as described, and will then move the first and second buckle portions apart generally along a transverse direction of the user and harness.

It will be appreciated that the above-described first buckle portion 100 (and corresponding, complementary second buckle portion 200) is merely exemplary and that such a buckle portion may be configured as desired. Various designs of buckle portions are described in detail, e.g., in U.S. Pat. Nos. 6,668,434, 8,181,319, and 9,993,048, and in U.S. Patent Application Publication 2011/0239413, all of which are incorporated by reference in their entirety herein. In some embodiments a first buckle portion will be of a design in which an opening 119 that is configured to receive a catch of a second buckle portion, is located at an end of the first buckle portion (e.g., as depicted herein in FIG. 5 and as described in detail above). In such a design, the opening is configured to receive a catch that is moved into opening 119 along a direction that is generally aligned with the longitudinal axis of the catch. Such an arrangement will be termed an “end-mating” design and will be distinguished from, e.g., a “side-mating” design in which a major side of the first buckle portion comprises an opening (e.g., a generally T-shaped opening) provided, e.g., in a base plate or cover plate of the buckle portion, through which a catch is inserted. Such a side-mating design is shown, for example, in FIG. 14A of U.S. Pat. No. 9,993,048. It will thus be appreciated that first and second buckles that are detachably attachable to each other to form a ventral buckle as disclosed herein, can be of any suitable type or arrangement and can rely on any appropriate latch or set of latches. Any such latch or latches may be biased in any suitable way, e.g., by a coil spring mounted in compression (as in the present case), a coil spring mounted in tension, a torsion spring, by the use of a magnetic biasing element, and so on.

Whatever the specific design, by definition a ventral buckle as disclosed herein comprises (at least) two buckle portions (e.g., a female portion and a male portion) that are in direct contact with each other and are attached to each other directly, by way of metal components of the buckle portions (e.g., the above-described latches, catches, and so on). Thus a ventral buckle as disclosed herein does not encompass an arrangement in which two “buckle portions” are attached to each other only by way of one or more flexible straps, webbing (made, e.g., of fabric) or the like. Furthermore, a ventral buckle 50 (and first and second buckle portions thereof) is an item that is configured specifically for use with body-supporting ventral straps of a fall-protection safety harness. Such a buckle will thus be distinguished from, for example, a buckle that may be used with one or more straps that are used to support the weight only of some relatively lightweight ancillary item (e.g., a hard hat, a tool, etc.) rather than being used with one or more harness straps that must take part in supporting the full weight of a user in the event of a user fall.

Whatever the specific design of the latching mechanism, any suitable first buckle portion will exhibit certain features and functionalities; similarly, any suitable second buckle portion will exhibit certain features and functionalities. For example, in many embodiments a second buckle portion 200 will comprise a main body 201 (from which the above-described catch 203 may extend) that defines a vertically-elongate slot 202 as described in detail earlier herein. In some embodiments, one or more auxiliary slots may also be present as described earlier herein. In some convenient embodiments, main body 201 and catch 203 may take the form of a single, integral body (e.g., made of a metal such as steel or aluminum) as in the exemplary design shown in FIG. 5.

Similarly, a first buckle portion 100 will comprise a slot-bearing body 107 that defines a vertically-elongate slot 106. In some embodiments, such a slot-bearing body may be an integral extension of base plate 101 or cover plate 102. However, in some embodiments it may be advantageous for slot-bearing body 107 to be pivotally connected to the remaining components (e.g., base plate 101 and/or cover plate 102) of first buckle portion 100. Thus in some embodiments, a slot 106 may be provided in a slot-bearing body 107 from which extends a connection arm 108 as shown in FIG. 5. Connection arm 108 may be connected to base plate 101 and cover plate 102 by way of a connector 105 that includes a shaft that extends through aligned apertures provided in connection arm 108 and in base plate 101 and/or cover plate 102. (The location of such an aperture 109 in connection arm 108 is generally indicated in FIG. 5, while the location of such apertures 125 in base plate 101 is indicated in FIG. 6.) Such an arrangement will connect slot-bearing body 107 with the other components of the buckle portion; in particular, such an arrangement allows a pivotable connection between slot-bearing body 107 and the base plate and cover plate. In such embodiments, the axis of rotation of the slot-bearing body 107 relative to the other components of the buckle portion will be defined by the long axis of connector 105 and will be at least generally aligned with the vertical axis of the harness and the ventral buckle. Such an arrangement may, for example, allow the first buckle portion, and the ventral buckle formed by attaching the first buckle portion to a second buckle portion, to more easily conform to the shape of a user's body.

A ventral buckle as disclosed herein will comprise at least one D-ring 104 (with the term D-ring denoting any suitable connecting item, regardless of the exact shape of the item) to which a safety line, lanyard, or the like can be connected. In some embodiments, such a D-ring may be a component of (i.e., may be permanently attached to) the first buckle portion 100 as in the exemplary design of FIGS. 4-6. In some convenient embodiments, such a D-ring 104 may be mounted on the same connector 105 on which the slot-bearing body 107 is mounted, as evident in FIG. 6. The D-ring thus may be pivotably connected to first buckle portion 100 and thus to the ventral buckle 50 formed therefrom. In the depicted embodiment, D-ring 104 is mounted so that it is pivotable from side to side; however, if desired, a D-ring could be mounted so that it is pivotable up and down.

In some embodiments first and second buckle portions 100 and 200 may be configured so that a vertically-elongate slot 106 of first buckle portion 100 is closely held in a specific orientation with respect to vertically-elongate slot 202 of second buckle portion 200. For example, in some embodiments, when buckle portions 100 and 200 are attached to each other, slot 106 may remain parallel to slot 202, e.g., to within plus or minus 5, 2 or 1 degree, at all times. In other embodiments, the buckle portions may be configured so that some variation in the relative orientation of slots 106 and 202 is allowed or promoted. Such variation may be allowed by, for example, allowing some “play” in the ability of catch 203 to slightly move relative to latches 112 (even while being held securely by the latches). Thus in various embodiments slot 106 of first buckle portion 100 may be able to pivot at least somewhat with respect to slot 202 of second buckle portion 200, e.g., through an angle of relative rotation of at least 5, 10 or 20 degrees or more. In some embodiments, the slots are unable to rotate relative to each other through an angle of more than 15, 7 or 3 degrees. Any such rotation will be about an axis of rotation that is generally aligned with the dorsal-ventral axis of the harness and buckle and buckle portions. Obviously, since (in the depicted embodiment) arm 108 is pivotably mounted on connector 105 with respect to rotation about a vertical axis as described above, such rotation about the vertical axis may occur to any suitable amount (e.g., up to 90 degrees or more) irrespective of any rotation that may or may not be allowed about a dorsal-ventral axis.

A feature of at least some of the embodiments disclosed herein is that at least when first and second buckle portions 100 and 200 are detached from each other, first buckle portion 100 can be slidably moved along first ventral strap 7, and second buckle portion 200 can similarly be slidably moved along second ventral strap 6. In other words, when buckle portions 100 and 200 are in the general configuration shown in FIG. 2, the user can slide each buckle portion upward or downward in a generally vertical direction, as desired. The route that the ventral straps follow through the buckle portions may cause enough frictional resistance that the buckle portions may not necessarily slide freely along the straps but rather may, in most instances, remain in place until deliberately moved by a user. In some embodiments, the presence of auxiliary slots as described above may contribute to such an effect. When both buckle portions are in the desired position, they can then be attached to each other. The upward/downward location of buckle 50 can thus be chosen as desired, e.g., to provide the best fit to the particular body shape of a user.

As noted, in many embodiments first and second buckle portions 100 and 200 and components thereof, may be made of any suitable material. In some embodiments, any such component may be made of any suitable metal, e.g., steel or aluminum. In various embodiments, such a component may be a forged body or a cast body; or, it may be made of sheet metal that is formed (e.g., bent) into the desired shape using standard sheet metal forming techniques. Typically base plate 101 and cover plate 102 may be manufactured separately and then brought together (with the latches, springs, etc. captured therebetween) and attached to each other by mechanical fasteners 103, e.g., rivets, to form first buckle portion 100.

In some embodiments, some part of a buckle portion (in particular, any areas that are to be regularly contacted by the fingers of a user) may be partially encased in an overmolded organic polymeric resin. Overmolding can be performed, e.g., by taking a previously-formed metal body and inserting it at least partially into an injection-molding cavity so that an organic polymeric molding resin can be formed atop, and adhered to, the desired portions of the body. In some embodiments a plate and/or padding may be provided, e.g., inward of first and/or second buckle portions 100 and/or 200, in order to provide enhanced cushioning between the ventral buckle 50 and the user's chest or torso. Any such plate and/or padding can be of any suitable design, relying, e.g., on one or more layers of foam or other resilient material.

A ventral buckle as disclosed herein (and a pseudo-crossover arrangement of ventral straps) can be used with any suitable fall-protection harness. Such harnesses are well known and may be used with a wide variety of fall-protection apparatus, methods and systems. In some embodiments, the fall-protection harness, and the ventral buckle thereof, may meet the requirements of ANSI Z359.12.

Fall-protection apparatus and systems (e.g., lanyards, self-retracting lifelines, positioning systems, horizontal systems, vertical systems, climb-assist systems, descenders, etc.), fall-protection anchorages, components of such apparatus, systems, equipment, and so on, with which the arrangements disclosed herein may find use, are described, e.g., in the 3M DBI-SALA Fall Protection Full Line Catalog 2018.

It is emphasized that a user of any fall-protection device, apparatus, system, or component thereof that includes a harness and/or ventral buckle as described herein is tasked with carrying out any appropriate steps, actions, precautions, operating procedures, etc., as required by applicable laws, rules, codes, standards, and/or instructions. That is, under no circumstances will the presence of any arrangement disclosed herein relieve a user of the duty to follow all appropriate laws; rules; codes; standards as promulgated by applicable bodies (e.g., ANSI); instructions as provided by the manufacturer of the fall-protection system, apparatus or components; instructions as provided by the entity in charge of a worksite, and so on.

It will be understood that the particular designs of the buckle portions presented herein are exemplary and that variations may be present but which may still allow buckle portions to form a ventral buckle that achieves a pseudo-crossover arrangement of straps. While the buckle portions (and 180 degree twist arrangements) disclosed herein are discussed primarily in the context of being used to form a ventral buckle for use with ventral straps of a fall-protection safety harness, in various embodiments such buckle portions and/or arrangements of straps could be used with other straps of a fall-protection safety harness, with straps of a general-purpose harness, or, with straps for any desired purpose. Such uses may not necessarily involve the interaction of two ventral straps with each other. Nor would the two straps necessarily need to be more or less parallel to each other when the buckle portions are detached from each other (as in FIG. 2) nor would they necessarily need to approach each other more or less tangentially when the buckle portions are attached to each other (as in FIG. 3). Rather, one strap might, e.g., approach the other strap more or less perpendicularly, or at any suitable angle. Thus, in various embodiments, the approaches disclosed herein may be used, e.g., to interconnect a ventral strap with a waist strap or a leg strap, a waist strap with a leg strap, and so on.

In summary, all such variations and combinations are contemplated as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). To the extent that there is any conflict or discrepancy between this specification as written and the disclosure in any document that is incorporated by reference herein but to which no priority is claimed, this specification as written will control.

1. A fall-protection safety harness configured so that when the harness is worn by a user, a first ventral strap of the harness extends from the right shoulder of the user to the right hip of the user and a second ventral strap of the harness extends from the left shoulder of the user to the left hip of the user,
wherein a first buckle portion is mounted on the first ventral strap and a second buckle portion is mounted on the second ventral strap, the first and second buckle portions being detachably attached to each other to form a ventral buckle;
and,
wherein the first and second ventral straps and the first and second buckle portions are configured so that the ventral buckle is at least generally aligned with a sagittal plane of the user and harness.

2. The fall-protection safety harness of claim 1 wherein no portion of the first ventral strap or the second ventral strap is aligned with the sagittal plane of the user and harness.

3. The fall-protection safety harness of claim 1 wherein at least one of the first and second ventral straps, and the buckle portion that is mounted on that ventral strap, are configured so that the ventral strap exhibits a 180 degree twist at the buckle portion.

4. The fall-protection safety harness of claim 3 wherein the buckle portion comprises an at least generally vertically-elongate slot that is oriented within plus or minus 20 degrees of a vertical axis of the harness and wherein the ventral strap exhibits the 180 degree twist as the ventral strap passes through the at least generally vertically-elongate slot of the buckle portion.

5. The fall-protection safety harness of claim 4 wherein a ratio of the elongate length of the at least generally vertically-elongate slot to a lateral width of the ventral strap that passes through the slot, is from 1.4 to 3.0.

6. The fall-protection safety harness of claim 4 wherein the ventral strap that exhibits the 180 degree twist as the ventral strap passes through the generally vertically-elongate slot of the buckle portion, comprises first and second strap sections that are in overlapping relation with each other, and further wherein at least a portion of the first and second strap sections that are in overlapping relation with each other are also in overlapping relation with an area of the buckle portion that partially defines the generally vertically-elongate slot of the buckle portion.

7. The fall-protection safety harness of claim 4 wherein the generally vertically-elongate slot is a substantially vertically-elongate slot that is oriented within plus or minus 10 degrees of a vertical axis of the harness; and wherein the buckle portion that comprises the substantially vertically-elongate slot also comprises at least one auxiliary elongate slot that exhibits a long axis that is oriented at an angle of from 15 degrees to 60 degrees relative to the substantially vertically-elongate slot.

8. The fall-protection safety harness of claim 7 wherein at least 80 percent of the elongate length of the at least one auxiliary elongate slot is positioned transversely outward of all portions of the substantially vertically-elongate slot.

9. The fall-protection safety harness of claim 7 wherein the at least one auxiliary elongate slot is in the form of upper and lower, oppositely-angled auxiliary elongate slots, each of the auxiliary elongate slots exhibiting a long axis that is oriented at an angle of from 15 degrees to 60 degrees relative to the substantially vertically-elongate slot.

10. The fall-protection safety harness of claim 1 wherein the first ventral strap and the first buckle portion that is mounted on the first ventral strap are configured so that the first ventral strap exhibits a 180 degree twist at the first buckle portion; and, where the second ventral strap and the second buckle portion that is mounted on the second ventral strap are configured so that the second ventral strap exhibits a 180 degree twist at the second buckle portion.

11. The fall-protection safety harness of claim 10 wherein the first buckle portion comprises a first generally vertically-elongate slot and wherein the first ventral strap exhibits the 180 degree twist as the first ventral strap passes through the first generally vertically-elongate slot of the first buckle portion; and, wherein the second buckle portion comprises a second generally vertically-elongate slot and wherein the second ventral strap exhibits the 180 degree twist as the second ventral strap passes through the second generally vertically-elongate slot of the second buckle portion.

12. The fall-protection safety harness of claim 11 wherein the first generally vertically-elongate slot of the first buckle portion is a first substantially vertically-elongate slot that is oriented within plus or minute 10 degrees of a vertical axis of the harness, and wherein the first buckle portion comprises upper and lower, oppositely-angled auxiliary slots each exhibiting a long axis that is angled from 15 to 60 degrees relative to the first substantially vertically-elongate slot;
and
wherein the second generally vertically-elongate slot of the second buckle portion is a second substantially vertically-elongate slot that is oriented within plus or minute 10 degrees of a vertical axis of the harness, and wherein the second buckle portion comprises upper and lower, oppositely-angled auxiliary slots each exhibiting a long axis that is angled from 15 to 60 degrees relative to the second substantially vertically-elongate slot.

13. The fall-protection safety harness claim 1 wherein when the first and second buckle portions are detached from each other, the first buckle portion is slidably movable along the first ventral strap and the second buckle portion is slidably movable along the second ventral strap.

14. The fall-protection safety harness of claim 1 wherein the first and second buckle portions are directly attached to each other by way of metal components of the first and second buckle portions and wherein the first and second buckle portions are not directly attached or connected to each other by way of any flexible strap or webbing.

15. The fall-protection safety harness of claim 1 wherein the first buckle portion comprises a base plate and a cover plate that are permanently attached to each other by multiple mechanical fasteners, and wherein the base plate and the cover plate of the first buckle portion are configured to define a receiving cavity into which a catch of the second buckle portion can be received in order to attach the first and second buckle portions to each other, and wherein the base plate and the cover plate also define an opening into which the catch of the first buckle portion can be inserted to reach the receiving cavity.

16. The fall-protection safety harness of claim 15 wherein the first buckle portion comprises first and second pivotable latches that are pivotably mounted to the base plate and/or to the cover plate and that are pivotably movable between a first, unlatched position that allows the catch of the second buckle portion to exit the receiving cavity of the first buckle portion to detach the first and second buckle portions from each other; and, a second, latched position that securely holds the catch of the second buckle portion within the receiving cavity of the first buckle portion and prevents the catch from being removed from the receiving cavity.

17. The fall-protection safety harness of claim 16 wherein the first and second pivotable latches of the first buckle portion are biased by biasing members toward the second, latched position, and wherein the first and second pivotable latches are configured so that the fingers of a user can overcome the biasing force of the biasing members and manually pivot the first and second latches from the second, latched position into the first, unlatched position by manipulating exposed ear portions of the first and second pivotable latches.

18. The fall-protection safety harness of claim 17 wherein the first and second pivotable latches of the first buckle portion are configured so that moving the first and second buckle portions toward each other in a transverse direction so that the catch of the second buckle portion enters the receiving cavity of the first buckle portion, causes a leading end of a head of the catch to impinge on contact surfaces of the first and second pivotable latches and overcomes the biasing force of the biasing members so as to urge the first and second pivotable latches to pivotably move to their second, unlatched position.

19. The fall-protection safety harness of claim 18 wherein the first and second pivotable latches of the first buckle portion are configured so that sufficient penetration of the catch of the second buckle portion into the receiving cavity of the first buckle portion causes the biasing force exerted by the biasing members to urge the first and second latches to automatically pivotably move into the second, latched position to securely hold the catch within the receiving cavity.

20. (canceled)

21. A method of donning the fall-protection safety harness of claim 1, the method comprising wrapping an upper portion of the safety harness about the shoulders and upper torso of the user in the manner of a jacket and then attaching the first and second buckle portions to each other to form the ventral buckle, wherein the method does not require any step of pulling the harness downward over the head and shoulders of the user in the manner of a pullover sweater.
